(19) United States
(12) Patent Application Publication
(10) Pub. No.: US 2007/0245307 A1
(43) Pub. Date: Oct. 18, 2007

(54) Embedded device

(75) Inventors: Wen-Yu Chu, Tu-Cheng (TW); Yung-Jui Chen, Tu-Cheng (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/592,843

(22) Filed: Nov. 2, 2006

(30) Foreign Application Priority Data
Feb. 24, 2006 (TW) 95106264

(51) Int. Cl. G06F 9/44

(52) U.S. Cl. 717/114

(57) ABSTRACT

An embedded device (10) for processing man-machine interface (MMI) operations includes a firmware module (20) and a description module (30). The firmware module is for implementing all functions of the embedded device, and includes an MMI kernel (200) for receiving and processing operation commands and displaying corresponding pictures. The MMI kernel includes a reading module (210), a storage module (220) connected to the reading module, and a drawing module (230) connected to the storage module. The description module is connected to the MMI kernel, and is used for saving description data of the pictures displayed by the MMI kernel. The reading module is for reading the description data saved in the description module. The storage module is for saving the description data read by the reading module. The drawing module is for searching description data corresponding to the operation commands and creating pictures according to the searched description data.

### BACKGROUND

1. Field of the Invention

The present invention relates to electronic devices, and particularly to an embedded device.

2. Related Art

An embedded system is a special-purpose system in which the computer is completely encapsulated by the device it controls. Embedded systems are usually designed to perform designated functions. Embedded systems have become popular due to low costs and high efficiency. Nowadays, embedded devices (devices containing embedded systems), include mobile phones, set-top boxes, servers, and personal digital assistants. Usually, the embedded devices comprise firmware, a combination of software and hardware. The software for performing different functions of embedded devices is developed on a computer before embedding the hardware therein.

In embedded devices having man-machine interfaces (MMI), MMI kernels usually include descriptions of window display content. Appearance and properties of windows content are included in the programs of the MMI. If windows of the MMIs need to be modified, the programs of the MMI must be edited individually, and the whole firmware of the embedded devices needs to be updated accordingly. Thus, it is inconvenient and inefficient.

### SUMMARY

An exemplary embodiment of the present invention provides an embedded device for processing man-machine interface (MMI) operations. The embedded device includes a firmware module and a description module. The firmware module is used for implementing all functions of the embedded device, and includes an MMI kernel for receiving and processing operation commands and displaying corresponding pictures. The MMI kernel includes a reading module, a storage module connected to the reading module, and a drawing module connected to the storage module. The description module is connected to the MMI kernel for saving description data of the pictures displayed by the MMI kernel. The reading module is used for reading the description data saved in the description module. The storage module is used for saving the description data read by the reading module. The drawing module is used for searching description data corresponding to the operation commands and creating pictures according to the searched description data. A method to arrange the embedded device is also be provided.

Other advantages and novel features will become more apparent from the following detailed description when taken in conjunction with the accompanying drawings, in which:

### BRIEF DESCRIPTION OF THE DRAWINGS

FIG. 1 is a block diagram of an embedded device of an exemplary embodiment of the present invention.

### DETAILED DESCRIPTION OF THE EMBODIMENTS

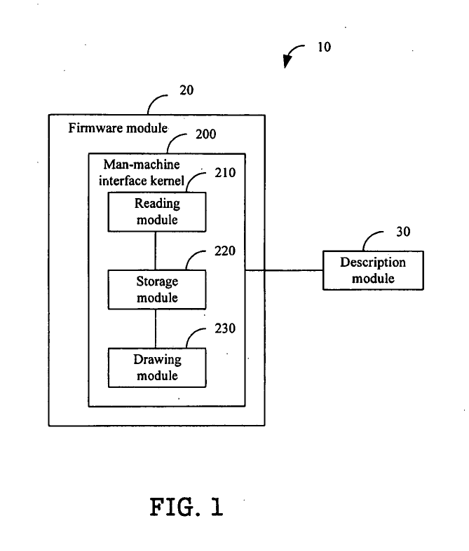

FIG. 1 is a block diagram of an embedded device 10 of an exemplary embodiment of the present invention. In the exemplary embodiment, the embedded device 10 includes cable modems, set-top boxes, mobile phones, and Voice over Internet protocol phones (VoIP), etc. The embedded device 10 is defined by methods to process man-machine interface (MMI) operations, and to include a firmware module 20 and a description module 30. The firmware module 20 implements all functions of the embedded device 10, and includes an MMI kernel 200. The MMI kernel 200 processes MMI operations. That is, the MMI kernel 200 receives and processes operation commands of users, and displays corresponding pictures. The MMI kernel 200 includes a reading module 210, a storage module 220, and a drawing module 230. The storage module 220 is connected to the reading module 210, and the drawing module 230 is connected to the storage module 220. The description module 30 is connected to the MMI kernel 200, and saves description data of all pictures displayed by the MMI kernel 200.

The reading module 210 is used for reading description data saved in the description module 30, and the storage module 220 is used for saving description data read by the reading module 210. In the exemplary embodiment, when the embedded device 10 is turned on, the reading module 210 reads all description data in the description module 30, and saves the read description data in the storage module 220. The drawing module 230 is used for searching description data corresponding to the operation commands saved in the storage module 220, and creates pictures according to the searched description data. When the MMI kernel 200 receives an operation command of a user, and processes the operation command, the drawing module 230 searches the storage module 220 to retrieve corresponding description data to create corresponding pictures. Then the MMI kernel 200 displays the corresponding pictures. For example, if the embedded device 10 is a mobile phone, when the MMI kernel 200 receives an operation command of picking up a call of a user, the MMI kernel 200 processes the operation command, and thus, the embedded device 10 is in a calling status. Then the drawing module 230 searches the storage module 220 to retrieve description data corresponding to the calling status, and creates a calling picture according to retrieved description data. Then, the MMI kernel 200 displays the calling picture.

In the exemplary embodiment, the description data saved in the description module 30 may be MMI description languages. In the exemplary embodiment, the MMI description languages may be extensible markup languages (XML). In the exemplary embodiment, each of the pictures displayed by the MMI kernel 200 includes a window, and the window includes a plurality of widgets. The description data saved in the description module 30 includes a plurality of window-data respectively corresponding to all pictures displayed by the MMI kernel 200. Each window data defines a window name and a common window property, and includes a plurality of widget data. In the exemplary embodiment, a window name may be an identifier of a window in the description data. The common window property includes an X coordinate, a Y coordinate, a width, and a height of a window. Each of the widget data defines a widget name, a type, and a common widget property. In the exemplary embodiment, a widget name may be an identifier of a widget in a window. The type of the widgets includes a textbox type and an edit-box type. The common widget property includes an X coordinate, a Y coordinate, a width, and a height of a widget. In the exemplary embodiment, the drawing module 230 is further used for creating widgets according to description data saved in the storage module 220.

If there is a need to modify the pictures displayed by the embedded device 10, developers and/or manufacturers can directly modify the description data in the description module 30 without updating firmware thereof. Thus, MMI development progress is expedited, which saves time and decreases development costs.

While embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

I claim:

1. An embedded device for processing man-machine interface (MMI) operations, comprising:
a firmware module, for implementing all functions of the embedded device, comprising an MMI kernel for receiving and processing operation commands and displaying corresponding pictures, the MMI kernel comprising a reading module, a storage module connected to the reading module, and a drawing module connected to the storage module; and
a description module connected to the MMI kernel, for saving description data of the pictures displayed by the MMI kernel;
wherein the reading module is used for reading the description data saved in the description module, the storage module is used for saving the description data read by the reading module, and the drawing module is used for searching description data corresponding to the operation commands and creating pictures according to the searched description data.

2. The embedded device as claimed in claim 1, wherein the description data saved in the description module comprises MMI description languages.

3. The embedded device as claimed in claim 2, wherein the MMI description languages comprise extensible markup languages.

4. The embedded device as claimed in claim 1, wherein each of the pictures displayed by the MMI kernel comprises a window comprising a plurality of widgets.

5. The embedded device as claimed in claim 4, wherein the description data comprises a plurality of window data.

6. The embedded device as claimed in claim 5, wherein each of the window data defines a window name and a common window property, and includes a plurality of widget data.

7. The embedded device as claimed in claim 6, wherein the common window property comprises an X coordinate, a Y coordinate, a width, and a height of a window.

8. The embedded device as claimed in claim 6, wherein each of the widget data defines a widget name, a type, and a common widget property.

9. The embedded device as claimed in claim 8, wherein the common widget property comprises an X coordinate, a Y coordinate, a width, and a height of a widget.

10. The embedded device as claimed in claim 8, wherein the type comprises a textbox type and an edit-box type.

11. The embedded device as claimed in claim 1, wherein the reading module reads all description data in the description module when the embedded device is turned on.

12. A device for processing man-machine interface (MMI) operations, comprising:
a firmware module of said device comprising an MMI kernel for implementing functions of said device through MMI and displaying corresponding pictures; and
a description module defined independently from said firmware module and data-communicable with said MMI kernel, said description module used for saving description data of said pictures and said description data being able to be provided to said MMI kernel when said MMI kernel implements said functions and displays said corresponding pictures according to said provided description data.

13. The device as claimed in claim 12, wherein said description data is expressed in extensible markup languages.

14. A method for defining a device to process man-machine interface (MMI) operations, comprising:
providing an MMI kernel in a device for implementing functions of said device and displaying corresponding pictures; and
independently saving description data of said pictures in a description module from said MMI kernel;
data-communicating said MMI kernel and said description module; and
providing corresponding description data to said MMI kernel when said MMI kernel displays said pictures based on said provided corresponding description data.

15. The method as claimed in claim 14, wherein said description data is expressed in extensible markup languages.
